(19) United States
(12) Patent Application Publication
(10) Pub. No.: US 2006/0143227 A1
(43) Pub. Date: Jun. 29, 2006

(54) System and method for persisting software objects

(76) Inventors: Martin W. Helm, Bad Schoenborn (DE); Martin K. Moser, Speyer (DE); Bernd H. Maier, Schwetzingen (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/023,917

(22) Filed: Dec. 27, 2004

(51) Int. Cl. G06F 7/00

(52) U.S. Cl. 707/103 Y

(57) ABSTRACT

Embodiments of the invention are generally directed to a system and method for persisting software objects. In an embodiment, objects are scanned with object introspection to identify the members of the object. The members are transformed into an intermediate data structure. The scan and transformation process can be influenced with configurable rules. If the object references another object, then the process is repeated recursively on the other object. Thus, in an embodiment, an entire object closure may be scanned and transformed into the intermediate data structure. The intermediate data structure is persisted in a data store.

### TECHNICAL FIELD

Embodiments of the invention generally relate to the field of data processing and, more particularly, to a system and method for persisting software objects.

### BACKGROUND

The term “persistence” refers to storing information on non-volatile media such as a database. Object persistence refers to persistently storing objects that are written in accordance with an object-oriented programming language such as Java. The term “Java persistence” is often used as a convenient way to describe persistently storing Java objects. Conventional approaches to Java persistence include Java Data Objects, object serialization, and bytecode rewriting.

The term “Java Data Objects (JDO)” refers to a persistency technology based, at least in part, on one of the JDO specifications such as Java Specification Request (JSR)-000012 entitled, “The Java Data Objects (JDO) Specification.” The JDO specification specifies a mechanism for transparently persisting Java objects. Transparently persisting Java objects means that the software that is used to access and modify the fields of an object follows the standard practice used in most Java applications. In order to implement JDO, however, it is necessary to identify which classes should be persistent. JDO uses a metadata file formatted in the extensible Mark Language (XML) to identify persistent classes.

Object serialization is a mechanism for writing the state of an object (and a graph of the objects it references) to a serial output stream. The serial output stream is written to a destination such as a file. The serial stream can be read from the file to reconstruct the object. Object serialization requires that each object implement a particular interface. For example, Java serialization based on the java.io.Serializable package requires that all serializable objects implement the interface java.io.Serializable.

Bytecode rewriting is directed to rewriting Java classes as they are loaded to a Java Virtual Machine (JVM). When the JVM detects a reference to an unloaded class, it sends a request to a class loader to load the class from the file system. In standard Java, the class is loaded directly to the JVM. In bytecode rewriting, however, a bytecode transformer is invoked to transform the class before it is loaded. The bytecode transformer can modify the class to add persistence logic.

These conventional approaches to Java persistence each impose a precondition on persistent objects. For example, object serialization requires that persistent objects implement a serializable interface. Similarly, JDO technology involves describing persistent objects with a JDO metadata file. Object persistency based on bytecode rewriting involves post-processing object bytecode.

### SUMMARY OF THE INVENTION

Embodiments of the invention are generally directed to a system and method for persisting software objects. In an embodiment, objects are scanned with object introspection to identify the members of the object. The members are transformed into an intermediate data structure. The scan and transformation process can be influenced with configurable rules. If the object references another object, then the process is repeated recursively on the other object. Thus, in an embodiment, an entire object closure may be scanned and transformed into the intermediate data structure. The intermediate data structure is persisted in a data store.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of selected elements of a persistence system implemented according to an embodiment of the invention.

FIG. 2 is a block diagram illustrating the structure of an object store Application Program Interface (API), according to an embodiment of the invention.

FIG. 3 illustrates a number of persistency methods used by the object store API, according to an embodiment of the invention.

FIG. 4 illustrates the process of generating an intermediate data structure, according to an embodiment of the invention.

FIG. 5 illustrates a simplified coding example for locating an appropriate constructor for instantiating a class, according to an embodiment of the invention.

FIG. 6 is a block diagram illustrating the structure of a persistence manager API, according to an embodiment of the invention.

FIG. 7 illustrates the persistency methods of the persistence manager API, according to an embodiment of the invention.

FIG. 8 illustrates a configuration file according to an embodiment of the invention.

FIG. 9 is a flow diagram illustrating certain aspects of a method for persisting an object according to an embodiment of the invention.

### DETAILED DESCRIPTION

Embodiments of the invention are generally directed to a system and method for persisting objects and object closures. In contrast to conventional persistency solutions, embodiments of the invention do not impose preconditions or requirements on persistent objects. In an embodiment, objects are scanned with object introspection to identify the members of the object. Introspection refers to the process of inspecting objects to obtain metadata about the objects. The term “dynamic introspection” refers to examining metadata of classes that are already loaded into a virtual machine (e.g., a Java Virtual Machine (JVM)). The members are transformed and stored into an intermediate data structure via a recursive scan and transformation algorithm. The functions of the scan and transformation algorithm can be influenced by a set of rules that allow, for example, avoiding a recursive scan of certain members and/or skipping other members altogether. The term “transform” refers to using an algorithm to determine how a member is represented in the intermediate data structure. The rules allow for the exclusion of parts of an object closure from the recursive scan and transformation. If the object references another object, then the process is repeated recursively on the other object. Thus, in an embodiment, an entire object closure may be scanned and transformed into the intermediate data structure. The intermediate data structure is persisted in a data store.

In an embodiment, a handle is returned when an object is stored. A handle is a Java object similar to a data base key, such that it uniquely identifies the stored object in the embodiment. In contrast to a data base key a handle is opaque, meaning that only the embodiment knows the exact implementation of a handle and can therefore manipulate it. Handles do not have any methods and applications cannot manipulate them; all they can do is pass handles on to the embodiment for processing. An object's handle can be used, for example, to retrieve the object from the embodiment. Handles themselves can also be stored in the embodiment, for example for bootstrapping purposes. To later retrieve such a handle from the embodiment, the handle must be stored under a unique name, which can be an arbitrary string. Handles that are stored under a name are also called “named handles”.

When an object is stored in the embodiment, not only the object itself, but also all objects that can be accessed from the object are also stored. A first object can be accessed from a second object if the second object either holds a reference to the first object, or the second object holds a reference to a third object, from which the first object can be accessed. The set of all objects that can be accessed from an object is called the object's closure, while the object is called the closure's anchor object. (Note that an object closure can have more than one anchor object, while not every object in a closure is also an anchor object of the closure.)

Finally, objects must be reachable in order to be retrieved from the embodiment. Per definition, all objects referenced by named handles are reachable. Further, all objects that can be accessed from reachable objects are reachable. All objects that are not reachable are called unreachable. Unreachable objects fill the database with no use. Such, they are removed during the data base garbage collection. (See below.)

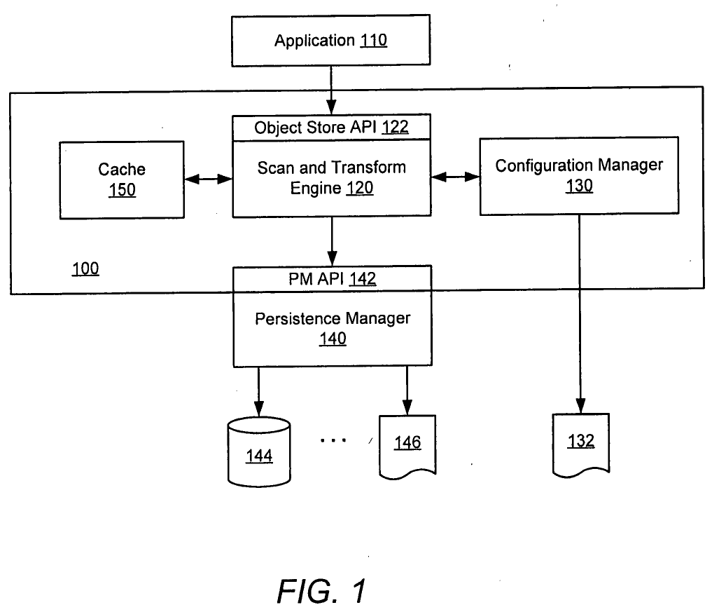

FIG. 1 is a block diagram of selected elements of a persistence system 100 implemented according to an embodiment of the invention. Persistence system 100 stores and retrieves objects and object closures for one or more applications such as application 110. The term “object closure” refers to a set of Java objects containing at least one reachable object and zero or more objects that are transitively referenced by the reachable object. A reachable object is an object that can be retrieved either directly or indirectly from, for example, persistence system 100. As is further described below, in an embodiment, a “named handle” is a starting point for retrieving objects. An object can be retrieved directly using its handle (as is further described below). An object can be retrieved indirectly as part of an object closure. Objects that are not reachable are called unreachable. Persistence system 100 treats a single object as the special case of a one element object closure. Consequently, when referring to object closures in the text below, the single object case is subsumed even if it is not specifically mentioned. In addition, embodiments of the invention are described with reference to Java objects. It is to be appreciated that alternative embodiments may be directed to persisting objects written in other programming languages.

In an embodiment, persistence system 100 is part of a multi-tiered network. The multi-tiered network may be implemented using a variety of different application technologies at each of the layers of the multi-tier architecture, including those based on the Java 2 Enterprise Edition™ (“J2EE”) specification (e.g., the Websphere platform developed by IBM Corporation), the Microsoft .NET platform, and/or the Advanced Business Application Programming (“ABAP”) platform developed by SAP AG. The J2EE specification refers to any of the J2EE specifications including, for example, the Java 2 Enterprise Edition Specification v1.3, published on Jul. 27, 2001. None of these technologies, however, are required by an embodiment of the invention.

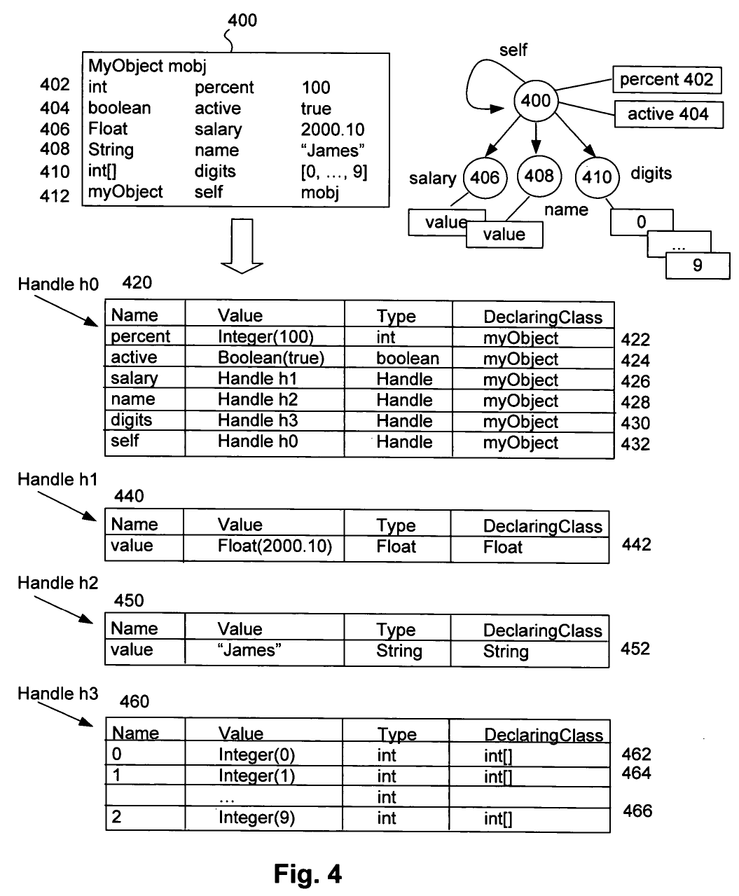

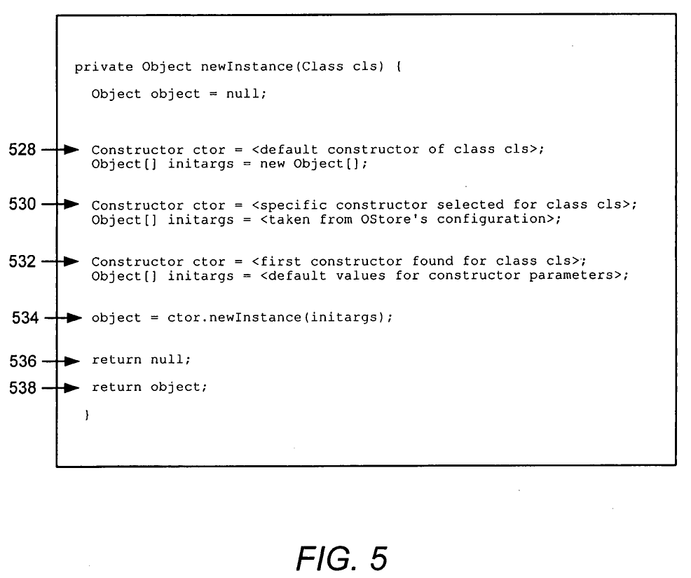

Persistence system 100 includes Scan and Transform Engine (STE) 120, object store Application Program Interface (API) 122, configuration manager 130, persistence manager API 142, and cache 150. In alternative embodiments, persistence system 100 includes more elements, fewer elements, and/or different elements. STE 120 uses introspection to scan and transform object closures. The transformed object closure is stored in an intermediate data structure and passed to persistence manager 140. STE 120 is further discussed below with reference to FIG. 4 through FIG. 5.

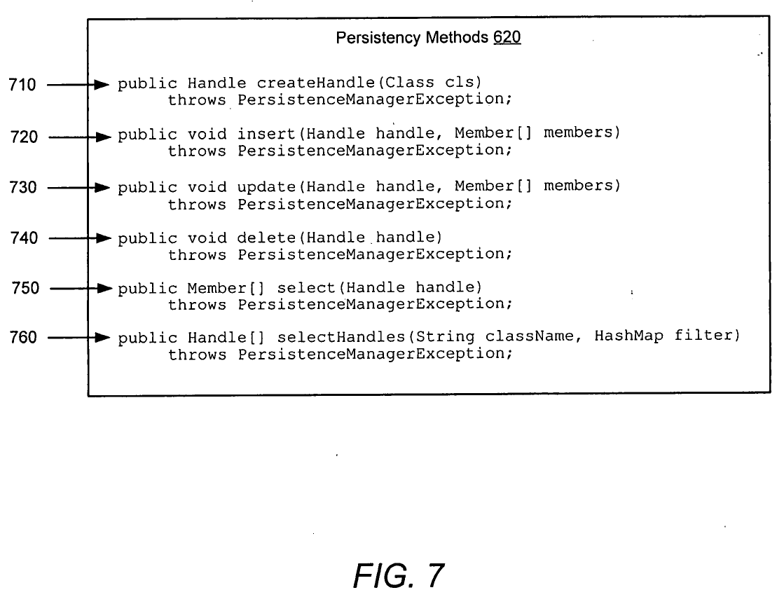

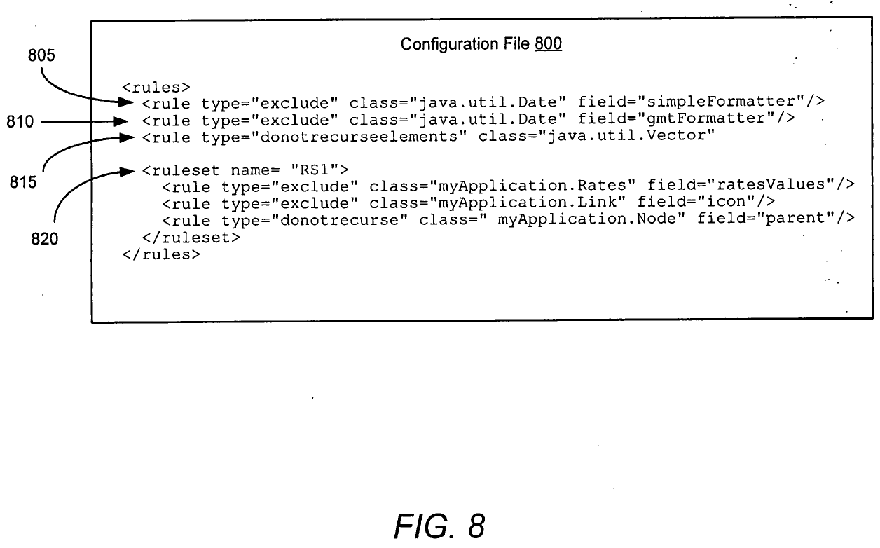

In an embodiment, configuration manager 130 provides STE 120 with rules that define, at least in part, the scan and transform process. Configuration manager 130 is further discussed below with reference to FIG. 8. Persistence manager 140 (and its Application Program Interface (API) 142) receives the intermediate data structure from STE 120 and writes it to a persistent media such as database 144, file system 146, and the like. Different Persistence Managers may be implemented for different persistent media. Persistence manager 140 is further discussed below with reference to FIGS. 7-8. In an embodiment, cache 150 holds a subset of the objects persisted by system 100 to improve the performance of the system.

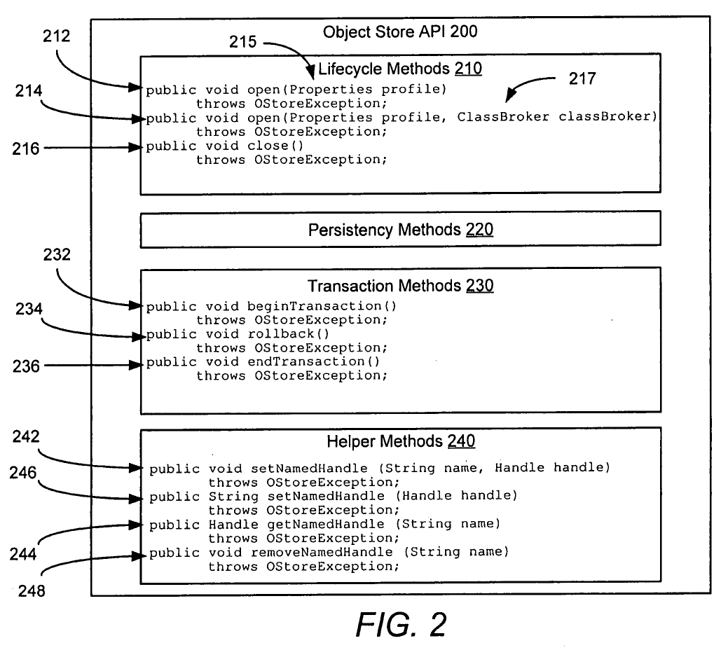

Object store API 122 provides the interface between application 110 and STE 120. FIG. 2 is a block diagram illustrating the structure of object store API 200 according to an embodiment of the invention. Object store API 200 includes lifecycle methods 210, persistency methods 220, transaction methods 230, and helper methods 240. In an alternative embodiment, object store API 200 may be structured to include more sets of methods, fewer sets of methods, and/or different sets of methods.

Lifecycle methods 210 initiate and end access to a persistence system (e.g., persistence system 100, shown in FIG. 1). The illustrated embodiment of lifecycle methods 210 includes open methods 212 and 214 as well as close method 216. Open methods 212 and 214 open persistence system 100 prior to use. Open methods 212 and 214 take profile object 215 as a parameter. Profile object 215 includes profile information for persistence system 100 such as a PersistenceManager class, a data store identifier, a configuration file, a username, and a password.

The PersistenceManager class is the fully qualified class name of the persistence manager that is used (e.g. persistence manager 140, shown in FIG. 1). A class typically has both a simple name and a fully qualified name. The simple name is the name given to the class in its definition. A “fully qualified” name also includes the name of the package of which the class is a part.

The data store identifier specifies which data store to use (e.g., database 144 and file system 146). The value of this property may depend on the persistence manager defined with the PersistenceManager class. For example, for a Java Database Connectivity (JDBC) persistence manager, the value of this property is a JDBC string pointing to a database (e.g., database 144). For a file based persistence manager this could be a file name or the fully qualified name of a directory.

The “configuration file” refers to a name (e.g., the fully qualified name) of a configuration file containing one or more rules for defining the behavior of, for example, STE 120. Referring again to FIG. 1, configuration manager 130 uses this information to access and read the configuration file (e.g., configuration file 132). In one embodiment, configuration file 132 is an XML formatted file stored in a file system. In an alternative embodiment, configuration manager 130 utilizes different media to store the configuration (e.g., “configuration store”). The rules defined in configuration file 132 define, in part, the scan and transform process of STE 120. Configuration file 132 is further discussed below with reference to FIG. 8.

Open method 214 is directed to applications that implement their own class loading. Persistence system 100 creates instances of application classes when retrieving persistently stored information. To create instances of application classes, persistence system 100 accesses the classes of the objects to be instantiated. The second parameter of open method 214 (e.g., classBroker parameter 217) enables persistence system 100 to have access to classes loaded by the application class loaders. In one embodiment, a class with a method Class classForName (className) uses the application class loaders to find the required classes.

Close method 216 closes persistence system 100. Closing persistence system 100 assures that clean-up operations, such as closing opened files or data bases, are properly executed to avoid data loss. Closing persistence system 100 also assures that system resources (e.g., memory, etc.) are returned to the system.

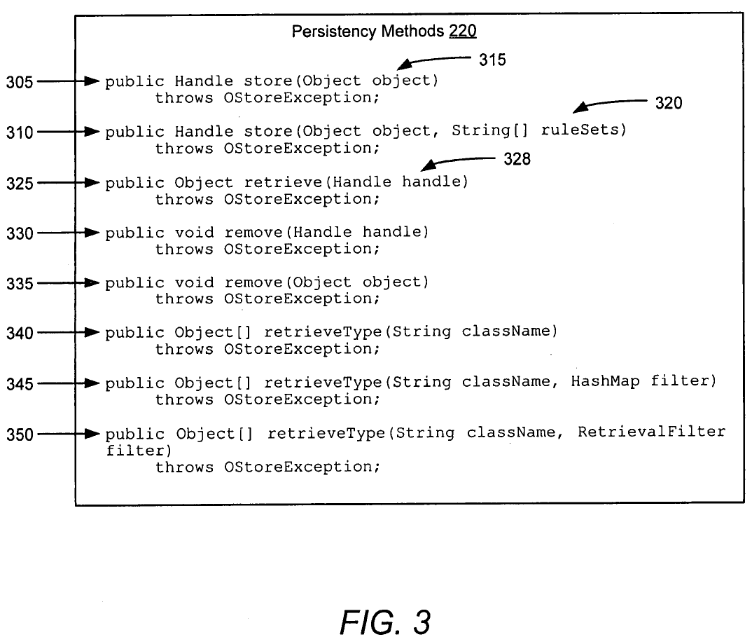

Persistency methods 220 provide access to objects stored in persistence system 100. FIG. 3 is an illustration of persistency methods 220 according to an embodiment of the invention. In an embodiment, store methods 305 and 310 persist data in persistence system 100. Store methods 305 and 310 first determine whether data (e.g., object 315) is already stored. If the object is already stored in persistence system 100, then the object is updated. If the object does not yet exist in the system, it is inserted. For both update and insert operations the whole object closure defined by the object is persisted. In other words, not only the object itself, but also all referenced objects are recursively stored (or updated) in the system. In either case, the handle for the stored object, that is the object closure's anchor object, is returned.

A handle object is an instance of a class that implements Handle. Handle instances are created by persistence system 100 rather than the application (e.g., application 110, shown in FIG. 1). The application uses the handles to retrieve stored objects. Nonetheless, handles themselves can be persisted explicitly, for example, for bootstrapping purposes. Such handles are called “named handles.” An application can create named handles using special OStore methods to store a handle under a name. The application can choose the name by itself. If the application, for example, uses a hard-coded string it can read the named handle back from OStore the next time the application runs. Based on the named handle, the application can then read its data from OStore.

An application can store and retrieve handles in persistence system 100 using names (e.g., based on java.lang.String). Thus, named handles serve as externally accessible “starting points” for object closures, and are useful for initial object retrieval from persistence system 100. For example, an application could use the class name of the application main class for a named handle, to retrieve an initial object closure. Then, the application can use handles stored within the initial object closure to access further objects in persistence system 100 and other named handles to access further closures.

Store method 310 is substantially similar to store method 305 but it also includes ruleSets parameter 320. RuleSets parameter 320 provides zero or more rule sets to define, at least in part, the behavior of STE 120. More precisely, RuleSets parameter 320 provides the name(s) of the rule stets. The rules/rule sets are defined in the rules/configuration file (e.g., configuration file 132, shown in FIG. 1). These rule sets may augment or override default rules that are provided by, for example, a configuration file (e.g., configuration file 132, shown in FIG. 1).

Retrieve method 325 is used to retrieve an object from persistence system 100. In an embodiment, the caller identifies an object closure to retrieve with a handle (e.g., handle 328). This handle is returned by store methods 305 and 310 during the store operation. In an alternative embodiment the retrieve method 325 could have an additional parameter ruleSet. This ruleSet is identical to the rule set of store method 310. The benefit of a rule set during a retrieve operation is to reduce the amount of data that has to be read from the data base. If, for example, for the retriever of an object closure only one member of the anchor object is of interest, a rule set can help to reduce the load on the data base: The rule set can prevent the embodiment from retrieving the whole object closure by excluding all members of the anchor object that refer to other objects. Such an alternative embodiment, however, cannot cache object closures retrieved with a rule set in the same way as object closures retrieved without a rule set: A later caller to retrieve is not aware of how the object closure was retrieved, and that it may be incomplete due to a rule set. Such, the cached object closure cannot be returned. There are at least two ways to handle objects retrieved with rule sets: a) do not cache them at all. b) Cache them with the rule set that was used to retrieve them. In the latter case the cached object closure may only be returned in case the rule set used during the first retrieve operation is a subset of the rule set used during later retrieve operations.

Remove methods 330 and 335 remove objects from persistence system 100. Remove method 330 identifies the object to be removed by passing its handle. Remove method 335 identifies the object to be removed by passing the object itself. Unlike store methods 305 and 310, remove method 335 is not recursively invoked on referenced objects. That is, only the object itself and not the object closure is removed from persistence system 100. Removing an object from persistence system 100 may render objects of the object closure unreachable. Thus, persistence system 100 periodically triggers a mechanism similar to the Java garbage collection mechanism to remove unreachable objects. The actual cleanup mechanism is implemented by the persistence manager (e.g., persistence manager 140, shown in FIG. 1). This mechanism can either be triggered periodically, or on demand, for example each time after the stored data is changed. In an alternative embodiment remove methods 330 and 335 could come with modified semantics and an additional parameter ruleSet: In the alternative embodiment the remove methods would remove the whole object closure, while the rule set would limit the scope of the remove operation in analogy to the rules for store and retrieve.

RetrieveType methods 340-350 enable a caller to retrieve a set of object closures with common features through one operation. RetrieveType method 340 retrieves all object closures of a specified class. The fully qualified class name is provided as a parameter for RetrieveType method 340.

RetrieveType method 345 is similar to RetrieveType method 340 but it reduces the result set by applying a filter. The filter works on a very low level without restoring the actual objects. The entries in the filter data structure (e.g., HashMap) are name/value pairs. The name of an entry is a string denoting a member of the class. It has the format <fully qualified class name>.<member name>. The fully qualified class name is used to discriminate members in the inheritance hierarchy, for example, when members are overwritten in a subclass. The value of an entry is either a String, or, for primitive types, an instance of the respective boxing class. RetrieveType method 345 returns those object closures that match the values in the filter data structure (e.g., HashMap).

RetrieveType method 350 is similar to RetrieveType method 345 but it employs a filter that is more powerful and less efficient. All instances of the class are retrieved as object closures from persistence system 100. The retrieved objects are then passed to the filter. The filter (e.g., a filter object) implements a method accept ( ), which can perform arbitrary computations on the object closures, and eventually returns a Boolean value. If the result for an object closure is true, then the object closure is added to the result, otherwise, it is ignored. In an alternative embodiment retrieveType methods could have an additional parameter ruleSet. In analogy to the retrieve method, the rule set could be used to restrict the scope of the retrieve operation with the benefit of less load on the data base.

Referring again to FIG. 2, transaction methods 230 are used to begin, end, and cancel transactions. Begin transaction method 232, begins a transaction. Rollback method 234 undoes the effect of all store and remove operations executed since the last begin transaction call. End transaction method 236 is called to actually persist (e.g., commit) the effects of all store and remove operations executed since the last begin transaction call. In an embodiment, each begin transaction operation is matched by either an end transaction operation or a rollback operation (in an embodiment, application 110, shown in FIG. 1, satisfies this constraint).

In an embodiment, helper methods 240 store and retrieve named handles. SetNamedHandle method 242 stores a handle that is identified by its name. Similarly, getNamedHandle method 244 retrieves a handle that is identified by its name. Method 246 is similar to method 242 except that it creates a unique name which is returned. Method 248 removes a named handle.

Referring again to FIG. 1, STE 120 examines and converts an object (e.g., a Java object) to an intermediate representation. The intermediate representation of the object is then passed to persistence manager 140. The object examination process uses introspection (e.g., Java introspection). In one embodiment, the Java Reflection API is used to implement the examination. Since persistency is based on introspection, no preconditions or requirements, like implementing certain interfaces (e.g., java.io.Serializable), inheriting from certain classes, or providing metadata (e.g., table or field definitions), are imposed on the objects.

In an embodiment, the intermediate representation of an object is a data structure, with one entry per member of the object. Each entry includes a name/value pair. In one embodiment, the name of each entry is a string consisting of the member's fully qualified class name and the member's name, separated by a dot (‘.’). Note that the member's class name is not necessarily the object's class. For members in which the object's class inherits from a superclass, the superclass's name is used. For example, consider two classes A and B. A defines a member a, and B inherits from A, and defines an additional member b. For an instance i of B, the name for b is B.b, while the name for a is A.a.

In one embodiment, the value of each entry is one of: the boxing class of a primitive type, a string, or a handle. The term “boxing” refers to converting a primitive type to a reference type. In one embodiment, strings are represented by the java.lang.String class. As is further described below, handles may be used when a member is itself composed of sub-members (e.g., when the member is an array).

Storing Objects

Three examples of scanning and transforming objects are discussed below. The first approach introduces a less complex example of an embodiment of the invention. The second approach introduces specific handling to improve performance (note that this is optional). The third approach refines the second by introducing rules to control what is stored and how it is stored. Note that numbers in brackets like “(n)” or “(n-m)” refer to code line n or lines n-m in the listings below. It is to be appreciated that the code listings that appear below are pseudo code (e.g., they resemble JAVA but are not “real” JAVA).

The first approach, as illustrated in Listing 1, shows the basic principle: All objects ultimately can be broken into arrays and primitive typed values like integer values (int), long values (long), floating point values (float), etc. When an object is stored (1) a distinction is made between arrays (2-3) and other kinds of objects (4-5).

When an object (which is not an array) is stored (8-19) all of the object's members are scanned, transformed, and stored. For each member (belonging to the object's class and its super classes) a dataset is created and collected in an intermediate data structure. The data structure is handed over to the persistence manager (17). There it is stored.

In an embodiment, a so-called class “Member” is used to collect a member's dataset: its name, value, type and the declaring class. The name is a string, the value is an object, the type and the declaring class are Java classes. The scan and transformation process guarantees that the value is only one of the following things: a string, an instance of a boxing class (Integer, Long, Float . . . ) or an instance of Handle. The type corresponds to the value: String.class, Integer.class, Long.class . . . Handle.class. The declaring class is necessary for the following reason: An object's member may not necessarily have been declared in the object's class itself. It may also have been declared in one of the object's superclasses. Consider two classes A and B. A declares a member a, and B inherits from A, and defines an additional member b. For an instance i of B, the declaring class of b is B while the declaring class for a (which is also present in i) is the declaring class in A.

In an embodiment, the intermediate data structure is an array of instances of Member. An object's member m can be both, of primitive type (an int, long, float . . . ) or any kind of object. If m is of primitive type, an instance of Member is created and added to the intermediate data structure (13). Note that the primitive typed member is stored as an instance of its corresponding boxing type—for example int 42 is stored as Integer(42); nevertheless the primitive type's class is stored (“int” not “Integer”) as type. The declaring class is the class declaring m (the object's class or one of int superclasses). If m is a kind of object then the algorithm is recursively called again (15) which ultimately results in a handle. The handle is stored instead of the object's value in a further instance of Member. This instance is added to the intermediate data structure, too (15). After all members of the object have been scanned and transformed, the intermediate data structure is handed over to the persistence manager where it is stored (17). Finally the object's handle h is returned to the caller (18). Note that handle h is not a result of storing the intermediate data structure—it is delivered by the persistence manger in a separate call (10). This is necessary for the following (simple) reason: If an object references itself (directly or indirectly) its handle must be known before storing its intermediate data structure, simply because the intermediate data structure contains the handle in one of the covered Member instances.

Storing an array (21-32) in fact resembles the handling of an object (8-19)—but with one important difference: An array does not have members like an object has, it has indexed elements. The scan and transformation process walks through all elements of an array and treats them in the same way it treats the members of an object: If element e is of primitive type it creates an instance of Member and adds it to an intermediate data structure (26), or—if element e is a kind of object—it (recursively) calls our algorithm again (28) and stores the resulting handle instead of the object's value in a further instance of Member. Note that, in the case of arrays, the array's class is taken as a member's declaring class (26) (28). The instance of Member is also stored in the intermediate data structure. Similar to the case of objects, the intermediate data structure is handed over to the persistence manager where it is stored (30). Finally the array's handle h is returned to the caller (31). Note that in the case of arrays instead of member names—which do not exist—an element's index is used as member name (26) (28).

LISTING 1

| | |
|---|---|
| 1 | Handle store(Object o) { |

| | |
|---|---|
| 2 | if o isArray |

| | |
|---|---|
| 3 | return storeArray(o) |

| | |
|---|---|
| 4 | else |

| | |
|---|---|
| 5 | return storeObject(o) |

| | |
|---|---|
| 6 | } |
| 7 | |
| 8 | Handle storeObject(Object o) { |

| 9 | IntermediateDataStruture i = new |
|---|---|
| | IntermediateDataStruture( ) |
| 10 | Handle h = persistenceManager.createHandle(o.class) |
| 11 | for all members m of o (of the object's class and its super |

classes) {

| | |
|---|---|
| 12 | if m is of primitiveType |

| 13 | i.add(new Member(m.name, m (boxed), |
|---|---|
| | primitiveType.class, |

declaringClass)

| | |
|---|---|
| 14 | else |

| 15 | i.add(new Member(m.name, store(m), |
|---|---|
| | Handle.Class, |

declaringClass)

| | |
|---|---|
| 16 | } |
| 17 | persistenceManager.insert(h,i) |
| 18 | return h |

| | |
|---|---|
| 19 | } |
| 20 | |
| 21 | Handle storeArray(Array a) { |

| 22 | IntermediateDataStruture i = new |
|---|---|
| | IntermediateDataStruture( ) |
| 23 | Handle h = persistenceManager.createHandle(a.class) |
| 24 | for all elements e of a { |

| | |
|---|---|
| 25 | if e is of primitiveType |

| 26 | i.add(new Member(toString(IndexOf(e)), |
|---|---|
| | e(being boxed), |

primitiveType.class, a.class)

| | |
|---|---|
| 27 | else |

| | |
|---|---|
| 28 | i.add(new Member(toString(IndexOf(e)), store(e), |

Handle.class, a.class)

| | |
|---|---|
| 29 | } |
| 30 | persistenceManager.insert(h,i) |
| 31 | return h |

| | |
|---|---|
| 32 | } |

The second approach adds to the first approach a specific handling for strings (see, e.g., code lines 34-35 and 68-74 below). This is done for performance reasons: Instead of storing a string ultimately as an array of characters (with probably hundreds of single character elements) strings are treated as strings. As all major data bases today have a native notion of strings, we assume that every persistence manager implementation also has a native notion of strings.

In an embodiment, when an object is stored (33) a distinction is made between strings (34-35), arrays (36-37), and other kinds of objects (38-39). Storing a string is handled as follows (68-74): The string is treated as a single-member object. The member is given the name “value”. The member's value is the string. The member's class and declaring class is String.class (71). An instance of Member is created and added to an intermediate data structure. The intermediate data structure is handed over to the persistence manager where it is stored (72). Finally, the string's handle h is returned to the caller (73). Storing arrays and other kinds of objects is described above with reference to the first approach. Listing 2 illustrates selected aspects of the second approach.

LISTING 2

| | |
|---|---|
| 33 | Handle store(Object o) { |

| | |
|---|---|
| 34 | if o isInstanceOf String |

| | |
|---|---|
| 35 | return storeString(o) |

| | |
|---|---|
| 36 | if o isArray |

| | |
|---|---|
| 37 | return storeArray(o) |

| | |
|---|---|
| 38 | else |

| | |
|---|---|
| 39 | return storeObject(o) |

| | |
|---|---|
| 40 | } |
| 41 | |
| 42 | Handle storeObject(Object o) { |

| | |
|---|---|
| 43 | IntermediateDataStruture i = new IntermediateDataStruture( ) |
| 44 | Handle h = persistenceManager.createHandle(o.class) |
| 45 | for all members m of o (of the object's class and its super |

classes) {

| | |
|---|---|
| 46 | if m is of primitiveType |

| | |
|---|---|
| 47 | i.add(new Member(m.name, m (being boxed), |

primitiveType.class, declaringClass)

| | |
|---|---|
| 48 | else |

| | |
|---|---|
| 49 | i.add(new Member(m.name, store(m), Handle.class, |

declaringClass)

| | |
|---|---|
| 50 | } |
| 51 | persistenceManager.insert(h,i) |
| 52 | return h |

| | |
|---|---|
| 53 | } |
| 54 | |
| 55 | Handle storeArray(Array a) { |

| | |
|---|---|
| 56 | IntermediateDataStruture i = new IntermediateDataStruture( ) |
| 57 | Handle h = persistenceManager.createHandle(a.class) |
| 58 | for all elements e of a { |

| | |
|---|---|
| 59 | if e is of primitiveType |

| | |
|---|---|
| 60 | i.add(new Member(toString(IndexOf(e)), e (boxed), |

primitiveType.class, a.class)

| | |
|---|---|
| 61 | else |

| | |
|---|---|
| 62 | i.add(new Member(toString(IndexOf(e)), store(e), |

Handle.class, a.class)

| | |
|---|---|
| 63 | } |
| 64 | persistenceManager.insert(h,i) |
| 65 | return h |

| | |
|---|---|
| 66 | } |
| 67 | |
| 68 | Handle storeString(String s) { |

| | |
|---|---|
| 69 | IntermediateDataStruture i = new IntermediateDataStruture( ) |
| 70 | Handle h = persistenceManager.createHandle(String.class) |

| | |
|---|---|
| 71 | i.add(new Member(“value”, s, String.class, String.class) |

| | |
|---|---|
| 72 | persistenceManager.insert(h,i) |
| 73 | return h |

| | |
|---|---|
| 74 | } |

The third approach extends the second (and the first) approach by introducing rules to control which and how things are stored (see, e.g., the italic parts of the code lines 75-126 below). The rules introduced in the third approach control whether a member is stored or not, whether the algorithm is applied recursively to a member object or not, and whether the elements of a container (like arrays, lists, sets, vectors . . . ) are excluded from the algorithm.

It is possible to declare that a certain object's member (of primitive type or any kind of object) is to be excluded from being stored (92-93). This is done using OStore's rule file. As a result the member will not be stored and—as a consequence—will be defaulted to a member type specific default when retrieved from the database. An application for this kind of rule is to prevent irrelevant fields from being stored. One example is cached values that are computed and held redundantly. Other examples are class constants. They need not to be stored.

It is possible to declare that a certain object's member shall not be scanned recursively by our algorithm (97-98). (This rule is only applicable for members that are objects, not for primitive type members.) This is done using OStore's rule file. Instead the object's handle is taken from the cache (97). To keep the object store consistent, however, in an embodiment it is mandatory that a member has been scanned recursively and stored earlier, before it can be excluded. The reason is because then the object is cached and its handle can be retrieved from the cache. It is an error if the object is not in the cache. As introduced in the first approach the handle is stored instead of the object's value (98). Excluding a specific member from being recursively scanned is desirable, for example, when within a tree structure each object not only points to its children but also to its parent. If such a tree's top object is stored, the complete tree is scanned following the children references and scanning back along the parent references is redundant. Excluding the parent link via a rule prevents the STM 120 from doing so.

It is possible to declare that a certain container's elements are not scanned recursively by the algorithm (99-102). This is done using OStore's rule file. Containers are objects like lists, sets, maps, vectors . . . and arrays. Ultimately all of the mentioned objects types store their elements within arrays. To exclude a container's elements from being scanned recursively the scan and transformation process is slightly modified by switching to the “doNotRecurseElements” mode. Therefore the doNotRecurseElements flag is set to true (100). After the container has been handled the mode is switched back by setting the doNotRecurseElements flag to false (102). The doNotRecurseElements flag is part of the “Flags” class—a simple data structure to cover boolean values (191-194). The structure is handed down recursively to the storeArray( ) method. If the scan and transformation process is in mode “doNotRecurseElements” an array's element (which is not of primitive type) is not scanned but its handle is taken from the cache (119). The handle is stored instead of the object's value (119). To keep the object store consistent, however, in an embodiment it is mandatory that a member has been scanned recursively and stored earlier, before it can be excluded. The reason is because then the object is cached and its handle can be retrieved from the cache. It is an error if the object is not in the cache. One example for applying the exclusion rule is the update of a node in a tree. Assume a tree structure has been persisted in OStore. Each node holds a list of references to its children. Now one node in the tree is to be updated. If the member for the children list cannot be excluded from the scan and transformation process, the whole sub-tree below the node will be updated, too. Excluding the member from the scan and transformation process improves the efficiency of the store method. Listing 3 illustrates selected aspects of the third approach.

LISTING 3

| | |
|---|---|
| 75 | Handle store(Object o) { |

| | |
|---|---|
| 76 | return store(o, new Flags( )) |

| | |
|---|---|
| 77 | } |
| 78 | |
| 79 | Handle store(Object o, Flags flags) { |

| | |
|---|---|
| 80 | if o isInstanceOf String |

| | |
|---|---|
| 81 | return storeString(o, flags) |

| | |
|---|---|
| 82 | else if o isArray |

| | |
|---|---|
| 83 | return storeArray(o, flags) |

| | |
|---|---|
| 84 | else |

| | |
|---|---|
| 85 | return storeObject(o, flags) |

| | |
|---|---|
| 86 | } |
| 87 | |
| 88 | Handle storeObject(Object o, Flags flags) { |

| 89 | IntermediateDataStruture i = |
|---|---|
| | new IntermediateDataStruture( ) |

| | |
|---|---|
| 90 | Handle h = persistenceManager.createHandle(o.class) |

| 91 | for all members m of o (of the object's class and |
|---|---|
| | its super |

classes) {

| | |
|---|---|
| 92 | if ruleManager.exclude(m) |

| | |
|---|---|
| 93 | continue with next member |

| | |
|---|---|
| 94 | else if m is of primitiveType |

| | |
|---|---|
| 95 | i.add(new Member(m.name, m(being boxed), |

primitiveType.class, declaring class)

| | |
|---|---|
| 96 | else { |

| | |
|---|---|
| 97 | if ruleManager.doNotRecurse(m) |

| 98 | i.add(new Member(m.name, cache.get(m), |
|---|---|
| | Handle.class, |

declaringClass)

| | |
|---|---|
| 99 | else if ruleManager.doNotRecurseElements(m) |

| 100 | flags.doNotRecurseElements = true |
|---|---|
| 101 | I.add(new Member(m.name, |
| | store(m, flags), |

Handle.class, declaringClass)

| | |
|---|---|
| 102 | flags.doNotRecurseElements = false |

| | |
|---|---|
| 103 | else |

| 104 | i.add(new Member(m.name, |
|---|---|
| | store(m, flags), |

Handle.class, declaringClass)

| | |
|---|---|
| 105 | } |

| | |
|---|---|
| 106 | } |
| 107 | persistenceManager.insert(h,i) |
| 108 | return h |

| | |
|---|---|
| 109 | } |
| 110 | |
| 111 | Handle storeArray(Array a, Flags flags) { |

| 112 | IntermediateDataStruture i = new |
|---|---|
| | IntermediateDataStruture( ) |
| 113 | Handle h = persistenceManager.createHandle(a.class) |
| 114 | for all elements e of a { |

| | |
|---|---|
| 115 | if e is of primitiveType |

| 116 | i.add(new Member(toString(IndexOf(e)), |
|---|---|
| | e(boxed), |

primitiveType.class, a.class))

| | |
|---|---|
| 117 | else { |

| | |
|---|---|
| 118 | if flags.doNotRecurseElements == true |

| 119 | i.add(new Member(toString(IndexOf(e)), |
|---|---|
| | cache.get(e), |

Handle.class, a.class))

| | |
|---|---|
| 120 | else |

| 121 | i.add(new Member(toString(IndexOf(e)), |
|---|---|
| | store(e, flags), |

Handle.class, a.class))

| | |
|---|---|
| 122 | } |

| | |
|---|---|
| 123 | } |
| 124 | persistenceManager.insert(h,i) |
| 125 | return h |

| | |
|---|---|
| 126 | } |
| 127 | |
| 128 | Handle storeString(String s) { |

| 129 | IntermediateDataStruture i = new |
|---|---|
| | IntermediateDataStruture( ) |
| 130 | Handle h = |
| | persistenceManager.createHandle(String.class) |
| 131 | i.add(new Member(“value”, s, String.class, String.class) |
| 132 | persistenceManager.insert(h,i) |
| 133 | return h |

| | |
|---|---|
| 134 | } |

FIG. 4 illustrates the process of generating an intermediate data structure, according to an embodiment of the invention. STE 120 identifies the elements of object 400 using introspection. In one embodiment, object 400 is a Java object and the Java Reflection API provides the introspection mechanism. Object 400 includes elements 402-412.

Java objects consist of members having one of the following member types: primitive types (int, long, double . . . ) or objects—strings, arrays or other kinds of objects.

STE 120 processes each member based, at least in part, on its member type. Table 1 provides processing rules for Java member types according to an embodiment of the invention. In an alternative embodiment, STE 120 may apply more rules, fewer rules, and/or different rules.

TABLE 1

| Member Type | Processing Rule |
|---|---|
| Has a primitive type | Create an instance of the member's |
| (byte, char, short, | boxing class with the member's value, |
| int, long, float, | and store it in the intermediate data |
| double, or boolean) | structure. |
| Is of type String | Store the member as it is in the |
| (e.g., java.lang.String) | intermediate data structure. |
| Is a reference to an object | Scan and transform the referenced |
| of type Array | array by looping over all array |
| | elements, and recursively apply the |
| | algorithm to the array elements. |
| | Storing the transformed array returns |
| | a handle which in turn is stored in |
| | the intermediate data structure as a |
| | placeholder for the referenced array. |
| Is a reference to another | Recursively apply this algorithm to |
| object | scan and transform the referenced |
| | object. Storing the transformed object |
| | returns a handle which in turn is |
| | stored in the intermediate data |
| | structure as a placeholder for the |
| | referenced object. Cyclic references |
| | are detected and addressed. In an |
| | embodiment, this rule applies to |
| | both instances of a built-in Java |
| | class and a user defined class. |

The rules shown above are sufficient to transform even complex object closures because all members of Java objects ultimately consist of primitive types and arrays. While strings might also be handled as character arrays, experience shows that the rule for strings shown above improves performance. This procedure is valid, because even the most primitive persistence managers have a native notion of strings.

Referring again to FIG. 4, table 420 illustrates an intermediate data structure corresponding to object 400. The entries in table 420 correspond to instances of class Member (see the discussion above with reference to listings 1-3). For each member of object 400 (402-412) a corresponding instance of class Member is created (422-432). Each instance covers an object member's name (Name column), a representation of its value (Value column), a type (Type column) and the declaring class (DeclaringClass column). Object members of primitive type (402, 404) are stored as objects of their corresponding boxing class (422, 424). The stored type is the original primitive type. Object members of any type of object (406-412) are transformed by the algorithm into further intermediate data structures (as illustrated by tables 440, 450, and 460) which are stored by the persistence manager—finally resulting in handles (e.g., handle h1, h2, h3). Handles are stored instead of the object (426-432). The stored type is Handle. Note the special case of a self-reference: Via member “self” (412) object 400 references itself. Consequently the intermediate data structure of object 400 covers an instance of class Member storing the corresponding handle h0 of object 400 (432).

Updating Objects

Updating objects works in substantially the same way as storing them for the first time. The main difference, with respect to the algorithm, is that instead of creating a new handle for objects that are going to be stored, the object's handle is read from the cache. All objects already having been stored or having been read from the database (which means that they also already have been stored some time ago) are available in the cache as long as the application is accessing them. So instead of asking the persistence manager for a new handle (10) (23) (44) (57) (70) (90) (113) (129), OStore asks the cache for the handle. Finally instead of calling persistenceManager.insert(h,i) (17) (30) (51) (64) (72) (107) (124) (132) OStore calls persistenceManager.update(h,i).

Retrieving Objects

When an object is retrieved the cache is checked at first (See, e.g., code line 136, show in listing 4) whether the object is already available or not. If yes, it simply can be returned. If not, at first the object's class is determined. The persistence manager (and only the persistence manager) is able to interpret a handle and to return the class of the object that corresponds to the handle (139). Dependent on the class a string (140-141), an array (142-143) or an object of another type (144-145) is retrieved.

To retrieve a string (148-152) its intermediate data structure is first retrieved from the persistence manager (149). The intermediate data structure of a string only has a single element—an instance of class Member. This instance's value member is taken to create a new string and to return it to the caller (151).

To retrieve an array (168-180) the array's class is first determined with the help of the persistence manager (169). After that the array's intermediate data structure is retrieved from the persistence manager (170). Then a new array with the required size is created (171). Now all instances of class Member—covered by the intermediate data structure—are evaluated (172-178): A Member instance's “name” member determines the related array's element index (173). A Member instance's “value” member determines the related array element's value (175). Note that if the value is a handle at first the corresponding object has to be retrieved. Therefore the retrieval process is called recursively (175)—ultimately resulting in the object represented by the handle. The retrieved object is assigned to the array's element (175). If the value is not a handle—which means that originally the element's value was of primitive type—the Member instance's “value” member can be assigned directly. Note that because the Member class stores all primitive typed values wrapped by it's boxing class, it is necessary to convert a boxing class object to a primitive type value before the assignment. When all elements of the arrays have been restored it is returned to the caller (179).

To retrieve an object (which is not an array) the object's class is first determined with the help of the persistence manager (155). After that the object's intermediate data structure is retrieved from the persistence manager (156). Then a new object is created (157). Creating the object is further described below with reference to FIG. 5. Now all instances of class Member—covered by the intermediate data structure—are evaluated (158-164). This process works in substantially the same way as in the case of an array (described above). The difference is that the final assignment is done to an object's members instead of an array's elements (161) (163). Listing 4 illustrates selected aspects of retrieving an object according to an embodiment of the invention.

LISTING 4

| | |
|---|---|
| 135 | Object retrieve(Handle h) { |

| | |
|---|---|
| 136 | Object object = cache.get(handle); |
| 137 | if object != null |

| | |
|---|---|
| 138 | return object |

| | |
|---|---|
| 139 | Class class = persistenceManager.getClass(h) |
| 140 | if class is String |

| | |
|---|---|
| 141 | return retrieveString(h) |

| | |
|---|---|
| 142 | else if class is an array class |

| | |
|---|---|
| 143 | return retrieveArray(h) |

| | |
|---|---|
| 144 | else |

| | |
|---|---|
| 145 | return retrieveObject(h) |

| | |
|---|---|
| 146 | } |
| 147 | |
| 148 | Object retrieveString(Handle h) { |

| | |
|---|---|
| 149 | IntermediateDataStruture i = persistenceManager.select(h) |
| 150 | for the only element e of i |

| | |
|---|---|
| 151 | return new String(e.getValue) |

| | |
|---|---|
| 152 | } |
| 153 | |
| 154 | Object retrieveObject(Handle h) { |

| | |
|---|---|
| 155 | Class c = persistenceManager.getClass(h) |
| 156 | IntermediateDataStruture i = persistenceManager.select(h) |
| 157 | Object o = newInstance(c) |
| 158 | for all elements e of i { |

| | |
|---|---|
| 159 | Field f = getField(c, e.getName( ), e.getDeclaringClass) |
| 160 | if e.getValue( ) isInstanceOf Handle |

| | |
|---|---|
| 161 | f.set(o, retrieve(e.getValue( ))) |

| | |
|---|---|
| 162 | else |

| | |
|---|---|
| 163 | f.set(o, e.getValue( )) |

| | |
|---|---|
| 164 | } |
| 165 | return o |

| | |
|---|---|
| 166 | } |
| 167 | |
| 168 | Object retrieveArray(Handle h) { |

| | |
|---|---|
| 169 | Class c = persistenceManager.getClass(h) |
| 170 | IntermediateDataStruture i = persistenceManager.select(h) |
| 171 | Object o = Array.newInstance(c, number of elements of i) |
| 172 | for all elements e of i { |

| | |
|---|---|
| 173 | int index = valueOf(e.getName( )) |
| 174 | if e.getValue( ) isInstanceOf Handle |

| | |
|---|---|
| 175 | Array.set(o, index, retrieve(e.getValue( ))) |

| | |
|---|---|
| 176 | else |

| | |
|---|---|
| 177 | Array.set(o, index, e.getValue( )); |

| | |
|---|---|
| 178 | } |
| 179 | return o |

| | |
|---|---|
| 180 | } |
| 181 | public class Member { |

| | |
|---|---|
| 182 | private String name; |
| 183 | private Class type; |
| 184 | private Object value; |
| 185 | private Class declaringClass; |
| 186 | public Member (String name, Object value, Class type, Class |

declaringClass) {

| | |
|---|---|
| 187 | . . . |

| | |
|---|---|
| 188 | } |
| 189 | . . . |

| | |
|---|---|
| 190 | } |
| 191 | public class Flags { |

| | |
|---|---|
| 192 | public boolean doNotRecurseElements; |
| 193 | . . . |

| | |
|---|---|
| 194 | } |

FIG. 5 illustrates a simplified coding example for locating an appropriate constructor for instantiating the class created above in listing 4. An attempt to obtain a default constructor is shown at 528. If a default constructor is not located, a configuration file (e.g., configuration file 132, shown in FIG. 1) is checked to see whether a specific constructor has been selected for the class at 530. If there is no default constructor and no specific constructor is selected in the configuration file, then the first constructor that can be for found for the class (e.g., for class cls) is used at 532. An attempt to execute the constructor is made at 534. If an error occurs, then the class is not instantiated as shown by 536. Otherwise, the object is returned at 538.

Referring again to FIG. 1, persistence manager 140 receives the intermediate data structure from STE 120. Persistence manager 140 then writes the data to a data store (e.g., database 144 or file system 146). In contrast to the other elements of persistence system 100, persistence manager 140 works on an object basis. That is, rather than storing and retrieving entire object closures, persistence manager 140 operates on the intermediate data structure of one object at a time. Typically, there is a different implementation of persistence manager 140 for each type of data store. Persistence manager API 142, therefore, defines an interface that can be implemented in multiple ways.

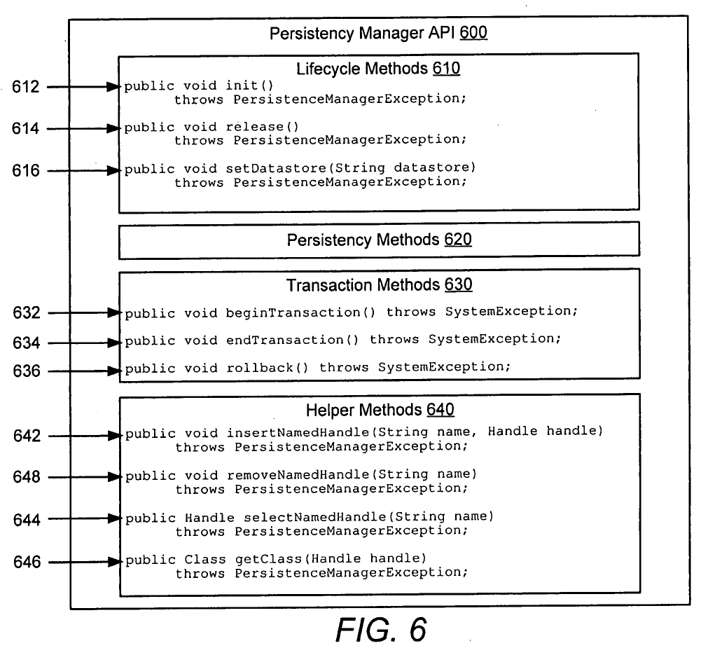

FIG. 6 is a block diagram illustrating the structure of persistence manager API 600 according to an embodiment of the invention. The illustrated embodiment includes lifecycle methods 610, persistency methods 620, transaction methods 630, and helper methods 640. In an alternative embodiment, persistence manager API 600 may include more sets of methods, fewer sets of methods, and/or different sets of methods.

Lifecycle methods 610 include initiate method 612, release method 614, and setDatastore method 616. Initiate method 612 is used to initialize a persistence manager prior to using it. Release method 614 releases the persistence manager after it is used so that resources can be returned to the system and cleanup, as needed, can be implemented. SetDatastore method 616 is used to define the data store for the persistence manager. This is a persistence manager specific string denoting the location where the data is stored (e.g., a JDBC string pointing to a database or a qualified name of a directory).

FIG. 7 is a block diagram illustrating persistency methods 620. When an object is stored, STE 120 provides a data structure with all of the object's members to the persistence manager. Before the data structure is inserted, a corresponding handle is generated to identify the data structure. In an embodiment, createHandle method 710 creates the handle based on the parameter className. In one embodiment, createHandle method 710 returns a unique handle that can be used to identify the object inside the persistence manager. When an object is stored, the objects referenced by the stored object are stored handles. Thus, when an object directly or indirectly references itself, its handle is created before it is stored.

Insert method 720 inserts an object (or rather its corresponding data structure) into the persistence manager. In an embodiment, insert method 720 takes as a parameter a handle created by createHandle method 710 to identify the inserted object. Update method 730 is used to update objects that were previously stored. The object is identified by its handle, which was created when the object was inserted.

Delete method 740 deletes an object that is stored in a data store. The object is identified by its handle, which was created when the object was inserted. In an embodiment, only the object identified by the handle is removed. All other objects of the object closure remain unchanged. Select method 750 returns an object (or rather its corresponding data structure) stored in the data store. The object is identified by its handle, which was created when the object was inserted.

In an embodiment, selectHandles method 760 returns the handles of all objects of a certain class stored in the persistence manager. The set of matching objects can be reduced by specifying a filter. In one embodiment, the provided filter is an object of type HashMap. Filters are further discussed above with reference to FIG. 3.

Referring again to FIG. 6, transaction methods 630 are used to begin, end, and cancel transactions. Begin transaction method 632, begins a transaction. Rollback method 634 undoes the effect of all store and remove operations executed since the last begin transaction call. End transaction method 636 is called to actually persist (e.g., commit) the effects of all store and remove operations executed since the last begin transaction call. In an embodiment, each begin transaction operation is matched by either an end transaction operation or a rollback operation. This constraint is fulfilled by the application (e.g., application 110, show in FIG. 1).

In an embodiment, helper methods 640 store and retrieve named handles. For example insertNamedHandle method 642 stores a handle that is identified by its name. Similarly, selectNamedHandle method 644 retrieves a handle that is identified by its name. Method 648 removes a named handle. In an embodiment, getClass method 646 returns the class (e.g., java.lang.Class) of the object identified by the provided handle. In an embodiment, only the persistence manager is able to interpret a handle.

Referring again to FIG. 1, configuration manager 130 provides a mechanism to control STE 120 in a rule based way. In an embodiment, the rules are, for example, defined in a configuration file 132. Configuration file 132 is, for example, an XML file. The path to the configuration file is handed over to persistence system 100 as one of its profile parameters when it is opened.

In an embodiment, the following rules are supported: excluding a specific member from being stored; excluding a specific member from being recursively scanned; and excluding the elements of a specific container from being scanned. In an alternative embodiment, more rules, fewer rules, and/or different rules are defined. Excluding a specific member from being stored is desirable, for example, when the member references runtime data that should not become part of the persistent store (e.g., cached data, rendered data, etc.). Excluding a specific member from being recursively scanned is desirable, for example, when within a tree structure each object not only points to its children but also to its parent. If such a tree's top object is stored, the complete tree is scanned following the children references and scanning back along the parent references is redundant. Excluding a container's elements from being scanned is desirable, for example, for VectorS because Vectors store references to their elements in an element array. Whenever a new element is added to a Vector, it is not necessary to update all elements of the Vector. Rather, it is sufficient to insert the new element and update the element array, which is already stored.

FIG. 8 illustrates a configuration file according to an embodiment of the invention. Rules are either mandatory or optional. A mandatory rule is always applied to the members of an object. An optional rule is only applied if it is explicitly requested (e.g., by ruleSets parameter 320, shown in FIG. 3). In one embodiment, optional rules are organized as rules sets. In the illustrated embodiment of configuration file 800, rules 805-815 are mandatory rules. The rules shown in rule set 820, however, are optional rules.

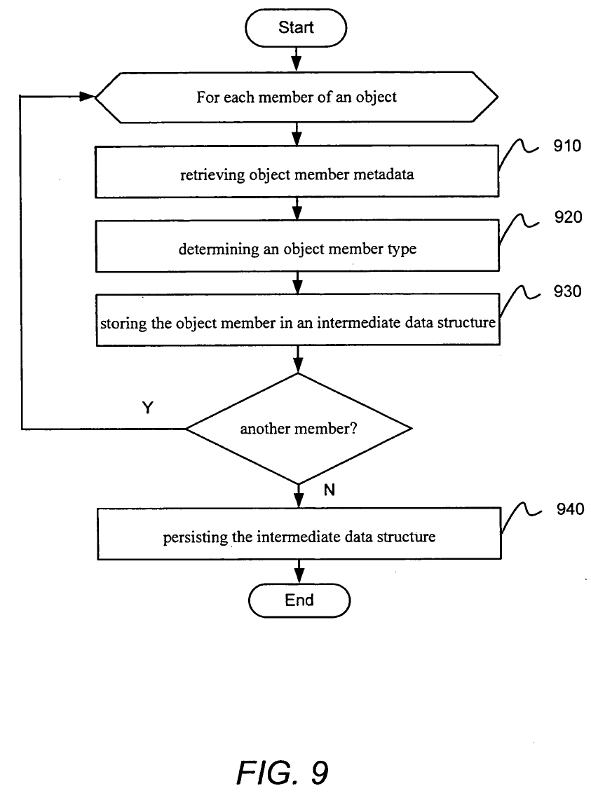

Turning now to FIG. 9, the particular methods associated with embodiments of the invention are described in terms of computer software and hardware with reference to a flowchart. The methods to be performed by a computing device (e.g., an application server) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement embodiments of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

FIG. 9 is a flow diagram illustrating certain aspects of method for persisting an object according to an embodiment of the invention. A persistence system (e.g., persistence system 100, shown in FIG. 1) persists an object having one or more object members. In an embodiment, a Scan and Transform Engine (e.g., STE 120, shown in FIG. 1) scans and transforms each member of the object. Referring to process block 910, object introspection is used to retrieve object metadata. Object metadata includes, for example, object member names. Referring to process block 920, an object member type is determined based at least in part on the retrieved object member metadata. For example, the object member type may be used to distinguish whether the object member is a primitive type, array, or reference to another object.

Referring to process block 930, each object member is stored in an intermediate data structure based, at least in part, on its object member type. Table 1 illustrates an algorithm for storing object members according to an embodiment of the invention. As discussed above with reference to FIG. 8, Mandatory and/or optional rules may also be used to determine whether and how to transform and store an object member.

Referring to process block 940, the intermediate data structure is persisted to a data store. The data store may be a database, a file system, and/or other store capable of providing non-volatile storage. In one embodiment, a persistence manager API provides an interface to one of several types of persistence managers. Each persistence manager is responsible for storing the information contained in the intermediate data structure onto a particular media.

Elements of embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

What is claimed is:

1. A method for persisting an object having one or more object members comprising:
for each object member,
retrieving object member metadata using dynamic object introspection,
determining an object member type based, at least in part, on the retrieved object member meta-information, and
storing the object member in an intermediate data structure based, at least in part, on the object member type;
persisting the intermediate data structure in a data store; and
obtaining a handle for the object responsive to persisting the intermediate data structure in a data store.

2. The method of claim 1, further comprising:
repeating the method of claim 1 for each object of an object closure.

3. The method of claim 1, wherein determining the object member type based, at least in part, on the retrieved object member metadata comprises:
determining whether the object member includes a primitive type; and
creating an instance of the object member's boxing class having a value corresponding to the primitive type, if the object member includes a primitive type.

4. The method of claim 3, wherein storing the object member in the intermediate data structure based, at least in part, on the object member type comprises storing the instance of the object member's boxing class in the intermediate data structure.

5. The method of claim 1, wherein determining the object member type based, at least in part, on the retrieved object member metadata comprises determining that the object member is of type string.

6. The method of claim 5, wherein storing the object member in the intermediate data structure based, at least in part, on the object member type comprises storing the object member as a string in the intermediate data structure.

7. The method of claim 1, wherein determining the object member type based, at least in part, on the retrieved object member metadata comprises:
determining that the object member is a reference to an array having zero or more array members; and
for each of the zero or more array members,
retrieving array member metadata using dynamic object introspection,
determining an array member type based, at least in part, on the retrieved object member meta-information, and
storing the array member in an intermediate data structure based, at least in part, on the object member type;
persisting the intermediate data structure in a data store; and
obtaining a handle for the array responsive to persisting the intermediate data structure in a data store.

8. The method of claim 7, wherein storing the object member in the intermediate data structure based, at least in part, on the object member type comprises storing the handle for the array in the intermediate data structure.

9. The method of claim 1, wherein determining the object member type based, at least in part, on the retrieved object member metadata comprises:
determining that the object member is a reference to another object having another one or more object members; and
for each of the other one or more object members,
retrieving object member metadata using dynamic object introspection,
determining an object member type based, at least in part, on the retrieved object member meta-information, and
storing the object member in an intermediate data structure based, at least in part, on the object member type;
persisting the intermediate data structure in a data store; and
obtaining a handle for the other object responsive to persisting the intermediate data structure in a data store.

10. The method of claim 9, wherein storing the object member in the intermediate data structure based, at least in part, on the object member type comprises storing the handle for the other object in the intermediate data structure.

11. The method of claim 1, wherein storing the object member in the intermediate data structure based, at least in part, on the object member type comprises storing one or more of:
a name;
a value;
a type; and
a declaring class.

12. The method of claim 11, wherein the value is one of:
a handle,
a string, and
an instance of a boxing class.

13. The method of claim 1, further comprising:
referencing configuration information, for each object member, to determine whether a rule applies to the object member.

14. The method of claim 13, further comprising:
excluding the object member from being stored in the intermediate data structure, if an exclusion rule applies to the object member.

15. The method of claim 14, wherein the object member includes a reference to another object and further comprising:
excluding the other object from a recursive application of the method of claim 13; and
storing a handle corresponding to the other object in the intermediate data structure.

16. The method of claim 14 wherein the object member is a container having zero or more container elements and further comprising:
excluding the zero or more container elements from a recursive application of the method of claim 13; and
storing a handle corresponding to the zero or more container elements in the intermediate data structure.

17. An apparatus comprising:
an application to provide an object having one or more object members; and
a processor and logic executable thereon to
for each object member,
retrieve object member metadata using dynamic object introspection,
determine an object member type based, at least in part, on the retrieved object member meta-information, and
store the object member in an intermediate data structure based, at least in part, on the object member type;
persisting the intermediate data structure in a data store;
obtaining a handle for the object responsive to persisting the intermediate data structure in a data store.

18. The apparatus of claim 17, wherein the logic executable thereon to store the object member in the intermediate data structure based, at least in part, on the object member type comprises logic to store one or more of:
a name;
a value;
a type; and
a declaring class.

19. An article of manufacture comprising:
an electronically accessible medium providing instructions for persisting an object having one or more object members that, when executed by an apparatus, cause the apparatus to
for each object member,
retrieve object member metadata using dynamic object introspection,
determine an object member type based, at least in part, on the retrieved object member meta-information, and
store the object member in an intermediate data structure based, at least in part, on the object member type;
persist the intermediate data structure in a data store; and
obtaining a handle for the object responsive to persisting the intermediate data structure in a data store.

20. The article of manufacture of claim 19, wherein the instructions that, when executed by the apparatus, cause the apparatus to store the object member in the intermediate data structure based, at least in part, on the object member type cause the apparatus to store one or more of:
a name;
a value;
a type; and
a declaring class.
